(19) United States
(12) Patent Application Publication
(10) Pub. No.: US 2011/0252755 A1
(43) Pub. Date: Oct. 20, 2011

(54) AIR PURIFYING DEVCE WITH MULTIFUNCTION FOR ERRADICATING HOUSE DUST MITES AND HEATING THE AIR

(76) Inventor: Shun-Hsiung CHANG, Yuanlin (TW)

(21) Appl. No.: 12/761,409

(22) Filed: Apr. 16, 2010

(51) Int. Cl. B01D 46/42; B01D 50/00

(52) U.S. Cl. 55/357; 55/385.6; 55/358

(57) ABSTRACT

A multifunction air purifying device which has functions for eradicating house dust mites, collecting dust and producing warm, cleaning air comprises of a main body (1) incorporates a printed circuit board (PCB) (5), an aspiring module (2) provided within said body, connected electrically to the PCB (5), multiple buttons disposed on a surface of the body (1) connect electrically to the PCB (5) and a handle (4) attached to the body (1). Said body (1) consists of a substrate (11), a cover (12) with a suction hole (121), and a base (13) with an exhaust hole (131). Said aspiring module (2) is composed of a housing (21) having an air intake (211) and an air outtake (212), a centrifugal fan (22), a motor (23), and a heating means (24).

### FIELD OF THE INVENTION

The present invention relates to a multifunction air purifier which can eliminate house dust mites and produce warm, purified air.

### DESCRIPTION OF PRIOR ART

House dust mites are a common cause of asthma and various allergic symptoms, they reside preferably in habitual condition with humidity and obscure, such as bedding, furniture or carpet. House dust mites can hardly be observed by naked eye, they are visible only against a dark background in normal light, which enhance the difficulty of eradication. It has been proved that house dust mite can be eliminated by exposing to temperature over 60° C. for a period of one hour, therefore, bedding or small furniture can be placed directly under sunlight for eradicating the house dust mites. However, large or heavy furniture which can't be moved to outside remain as objects providing suitable habitual condition for the house dust mites.

Thus, to find an air purifying or cleaning apparatus which possesses multifunction as to eradicate house dust mites, and generating warm air as a heater while purifying air has become the main objectives of the present invention.

### SUMMARY OF THE INVENTION

To achieve foregoing objectives, a multifunction air purifying device comprises of a main body, an aspiring module provided within said body, a printed circuit board (PCB) connected electrically to said aspiring module, and a plurality of buttons, connected electrically to the PCB are disposed on a surface of the body, and characterized in that: said body consists of a substrate, a cover with a suction hole provided at an end thereof is disposed above said substrate, a base with an exhaust hole provided at an end thereof is disposed under said substrate; said base further includes a power socket connected electrically to the PCB for electricity connection.

Said aspiring module includes a housing which has an air intake corresponding and connecting with the suction hole of the cover, and an air outtake corresponding and connecting with the exhaust hole of the base, a centrifugal fan provided about said air intake, a motor for driving said fan, and a heating means provided about said air outtake; and

Said buttons includes a switch button for controlling the power, a plurality buttons for controlling function of said motor and a button for operating said heating means.

By coupling the suction hole to an active carbon filter, the device function as an air purifier, in which air is inhaled and cleaned by the device. As the suction hole couples to a nozzle which connected to a hose, the device can be served as a conventional vacuum cleaner. The aspiring module and the cap set outside the exhaust hole eradiate efficiently the house dust mites and their eggs resided on the bedding or furniture; the heating means produces hot air, destroying the habitual condition thereof and to warm the bed to increase comfort. A container filled with essential oil can be placed above said heating means, providing aroma to the space while purifying air.

### BRIEF DESCRIPTION OF DRAWINGS

FIG. 1 is a perspective view of the multifunction air purifying device.

FIG. 2 is a schematic view of the air purifying device in which the suction hole couples to a filter.

FIG. 3 is a schematic view of FIG. 2 showing retraction of legs in arrows.

FIG. 4 is a side view of the FIG. 2.

FIG. 5 is an exploded view of the air purifying device as shown in FIG. 2.

FIG. 6 is an exploded view of an aspiring module incorporated into the present invention.

FIG. 7 is a schematic view of the air purifying device in which the suction hole couples to a nozzle.

FIG. 8 is a schematic view of FIG. 7 showing retraction of legs in arrows.

FIG. 9 is an exploded view of the air purifying device as shown in FIG. 7.

FIG. 10 is an explanatory view demonstrating the device functioned as an air purifier coupled to a heat resistant cushion.

FIG. 11 is an explanatory view demonstrating the device functioned as a vacuum cleaner.

### DETAILED DESCRIPTION OF PREFERRED EMBODIMENT

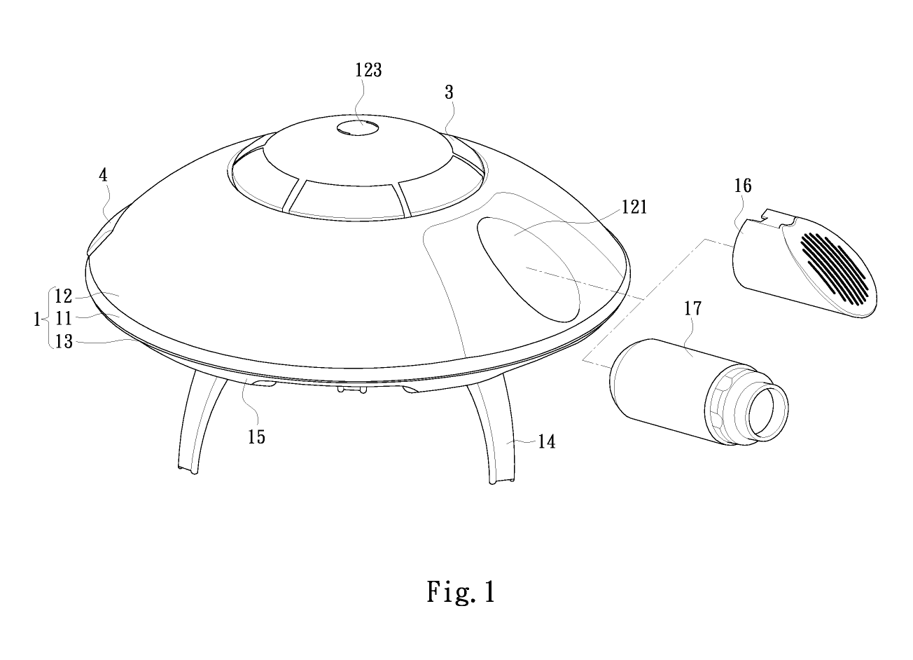

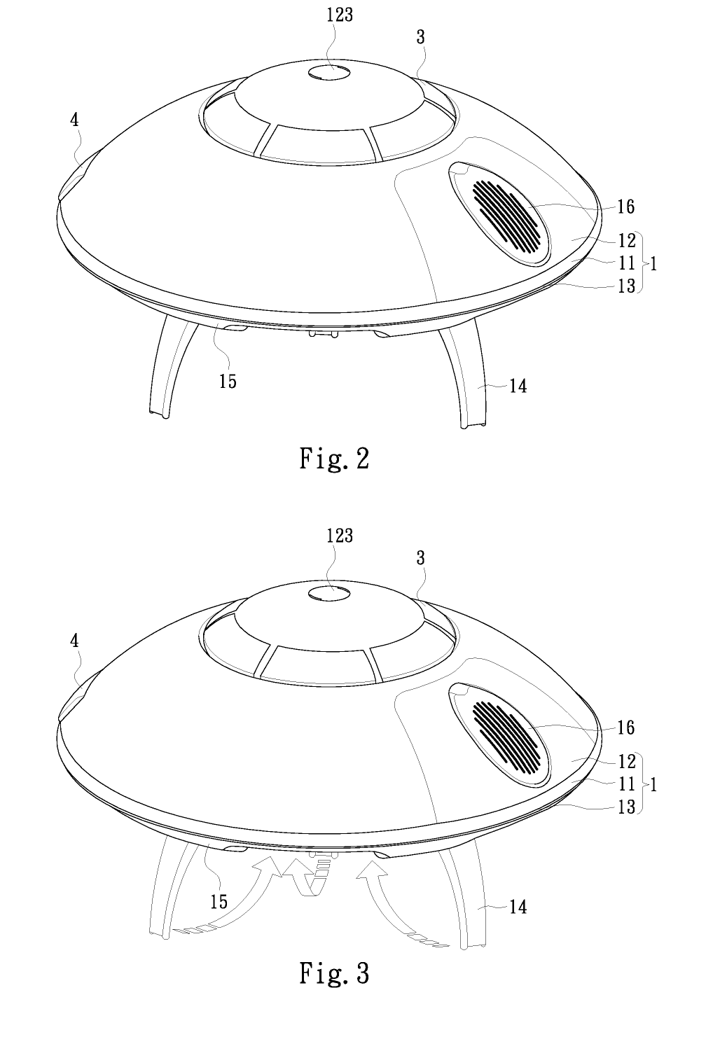

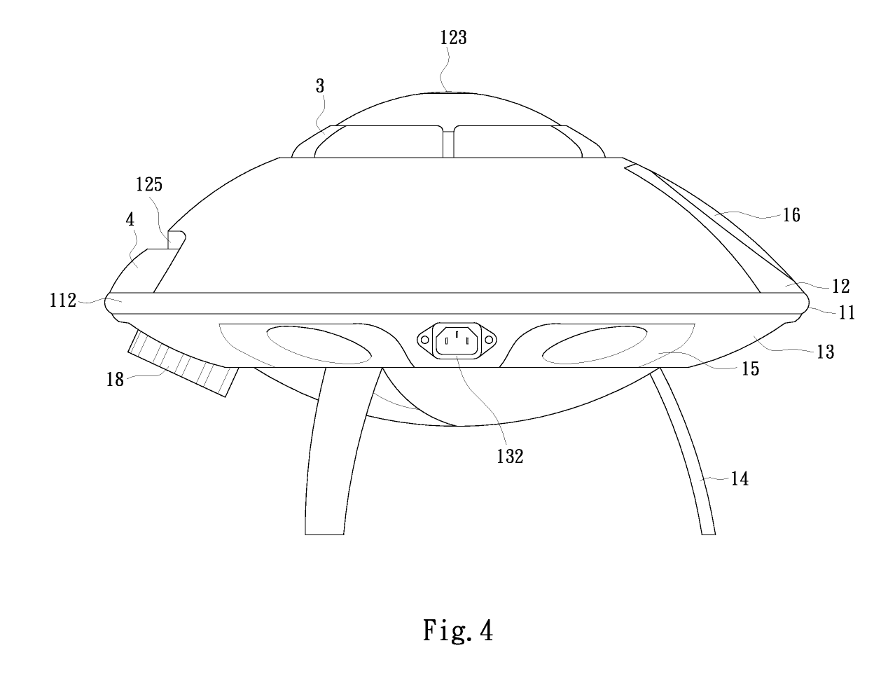

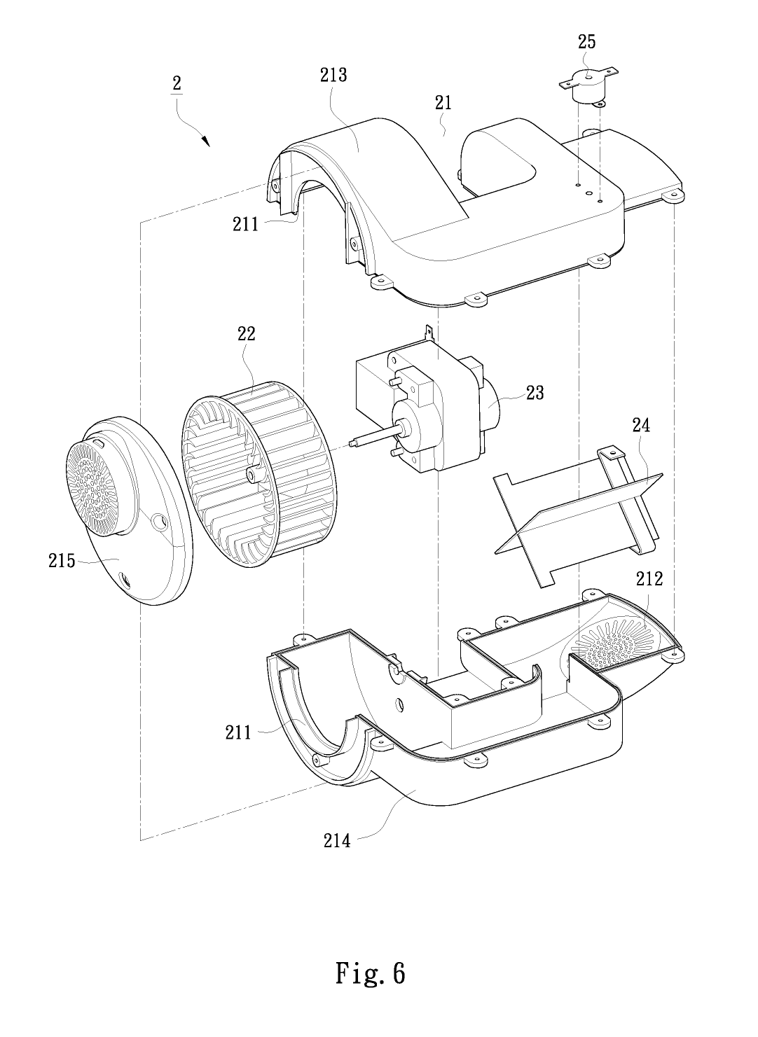

Referring to FIGS. 1-6, a multifunction air purifying device comprises of a main body (1), an aspiring module (2) provided within said body (1), a printed circuit board (PCB) (5) connected electrically to said aspiring module (2), a plurality of buttons (3) connected electrically to the PCB (5) are disposed on a surface of the body (1), and a handle (4) attached to the body (1) for providing portability to the device. Said air purifying device is characterized in that: said body (1) consists of a substrate (11), a cover (12) with a suction hole (121) provided at an end thereof is disposed above said substrate (11), a base (13) with an exhaust hole (131) provided at an end thereof is disposed under said substrate (11). The aspiring module (2) includes a housing (21) which has an air intake (211) corresponding and connecting with the suction hole (121) of the cover (12), and an air outtake (212) corresponding and connecting with the exhaust hole (131) of the base (13), a centrifugal fan (22) provided about said air intake (211), a motor (23) for driving said fan (22), and a heating means (24) provided about said air outtake (212). The blade of the fan (22) can be made with a curvature similar to the blade of a turbine fan to increase the air inflow rate. Said base (13) further includes a power socket (132) which connected electrically to the PCB (5) for electricity connection.

Plurality legs (14) are disposed in a circular fashion at the bottom of the base (13) for supporting the base (13). Each leg (14) joints the base (13) by two posts (141) which each is provided respectively at two ends of a top thereof, thus the leg (14) may pivot inwardly as shown in FIG. 3 to reduce occupied space. A guard (15) is further attached to the bottom of said base (13) to avoid disengagement of legs (14); and a plurality of grooves (151) are provided at a bottom of said guard (15) for accommodating the legs (14).

A container (122) for reserving liquid is provided at a top of said cover (12); said container (122) is sealed by a cap (123) to avoid the liquid within being spilled by the movement of the device. The liquid, such as essential oil is delivered by a delivery pipe (124) whose one end attached to the bottom of the container (122), and an another end thereof connected to the housing (21) of the aspiring module (2). The essential oil transferred to the housing (21) evaporates and provides aroma to the air.

A thermal control device (25) is provided at top of the housing (21) where is close to the air outtake (212) for connecting with the delivery pipe (124). The thermal control device (25) is shut down automatically at 75° C. to reduce the evaporating rate of the essential oil. Said thermal control device (25) can be any temperature control unit known by the person having ordinary skill in the art, thus no detailed function is described further.

A strainer cover (16) or a nozzle (17) can be selected to couples with the suction hole (121). Said strainer cover (16) incorporates filter made of active carbon to fresh the air, and structure and function of the nozzle are described hereinafter.

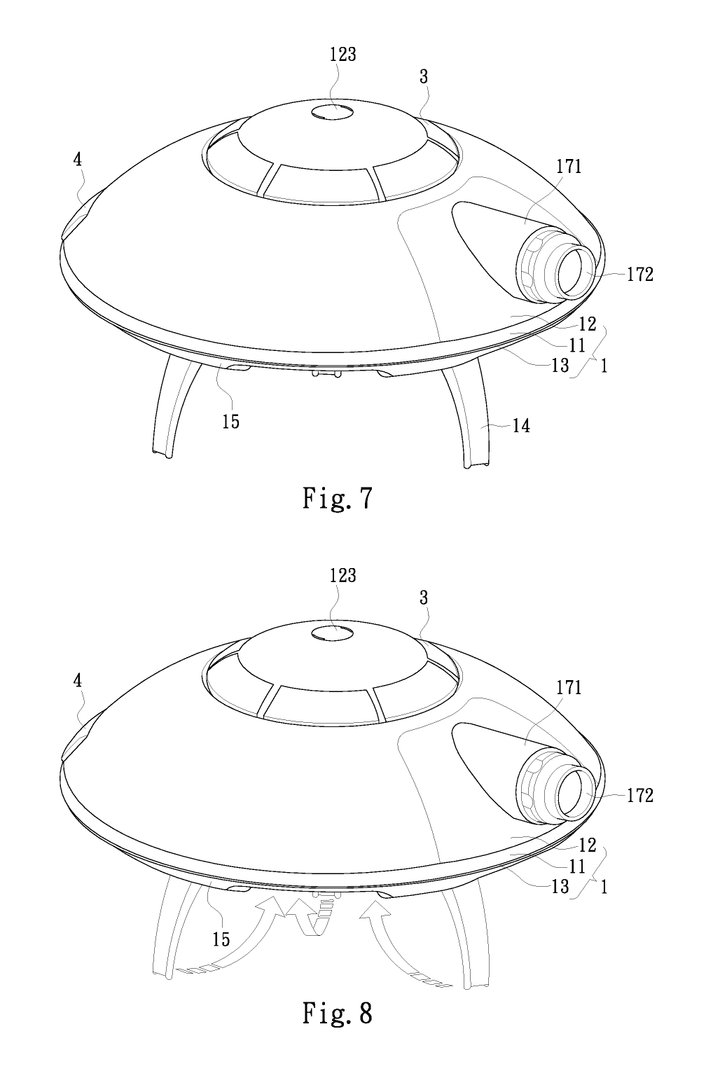

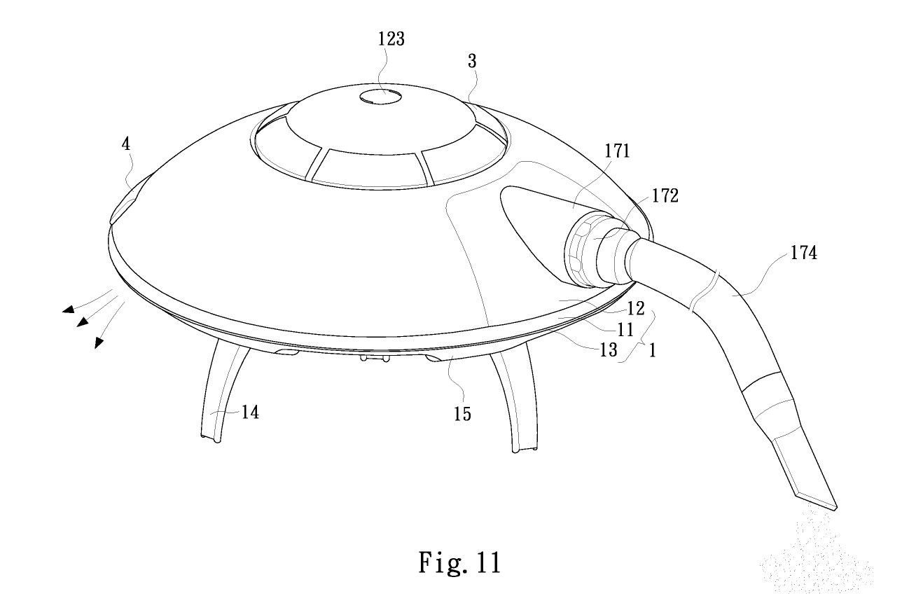

Referring to FIGS. 7-11, the suction hole (121) and the nozzle (17) are engaged. Said nozzle (17) comprises of a tube (171) which an end thereof engaged to the suction hole (121), and another end engaged to an adapter (172) for connecting to a suction pipe (174); and a filter (173) provided between said tube (172) and adapter (174).

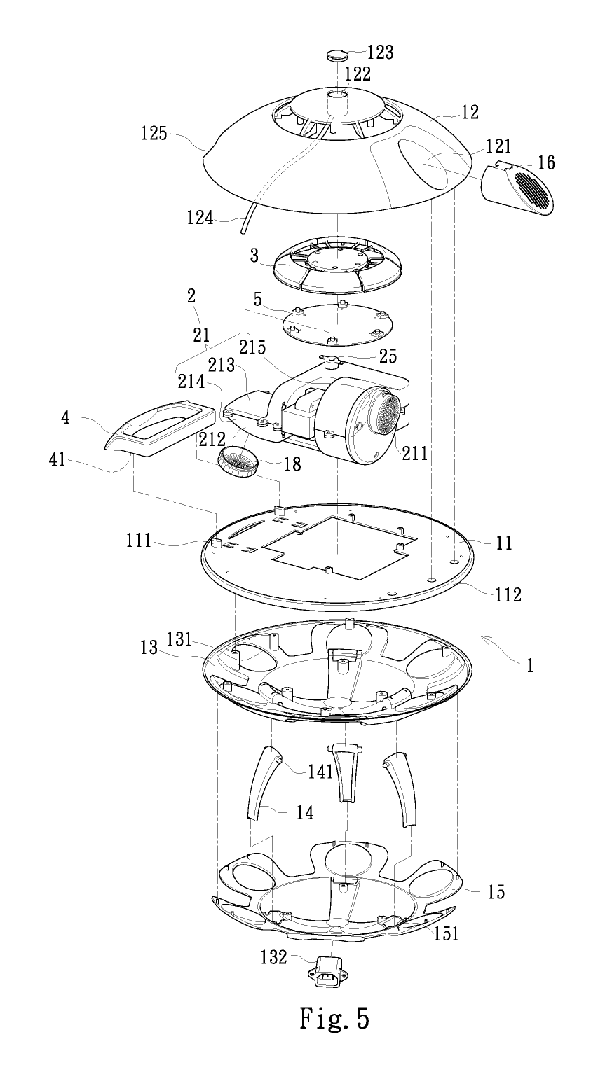

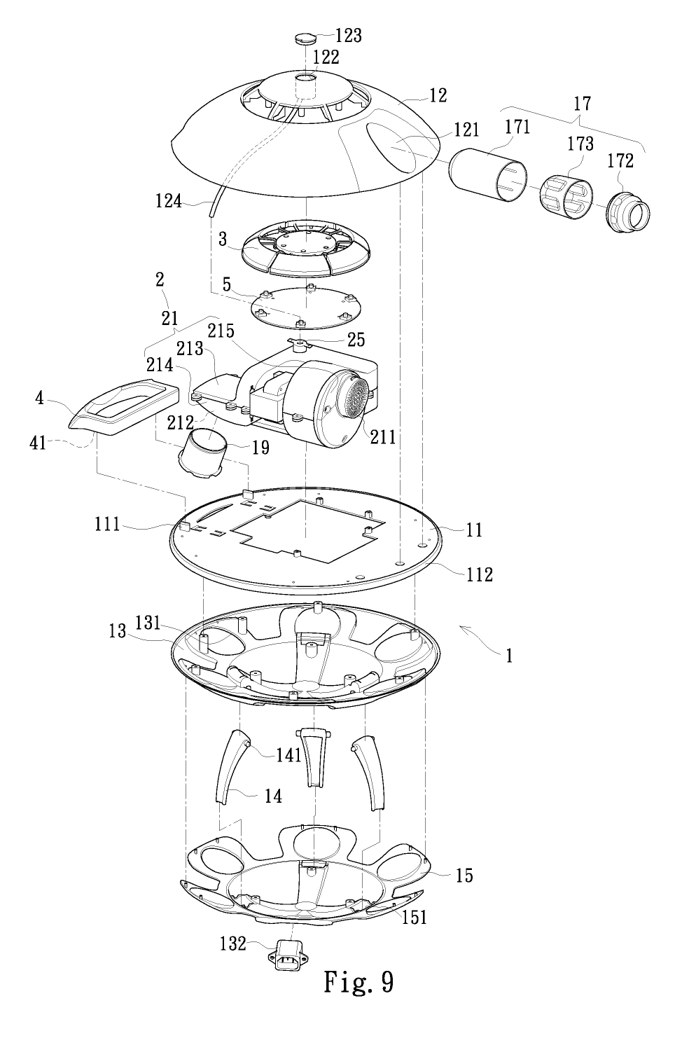

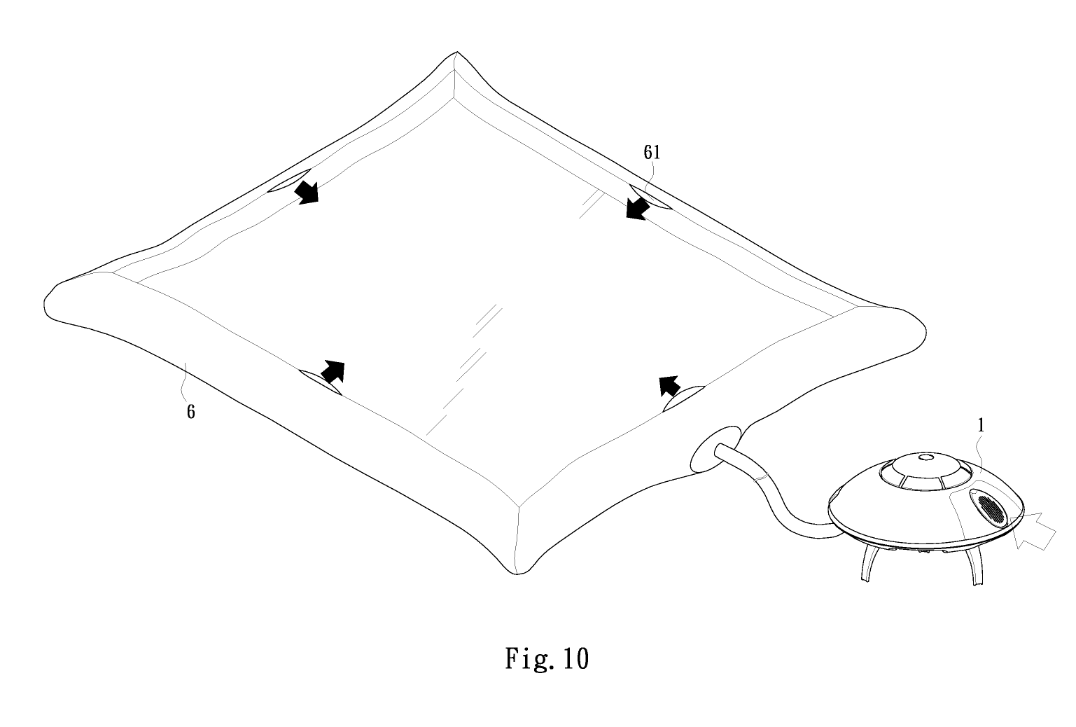

The exhaust hole (131) of said air purifying device can engages to an air filtering cap (18) as shown in FIG. 5, or a pipe assembly (19) as shown in FIG. 9. The cap (18) can prevent house dust mites and their fecal sucked by the aspiring module (2) from back to the air, reducing possibility of allergic symptoms contract to people in the room. The pipe assembly (19) can further attach to a heat resisting cushion (6) having a central recessed section for receiving mattress or pillow, as shown in FIG. 10. The pipe assembly (19) delivers hot air to the cushion (6) and has it outputted from openings (61) to heat bedding accommodated in the center thereof for simply preheating the bedding or eliminating house dust mites by rising temperature over 60° C.

The heating means (24) can be selected from an electric heating plate, an electric heating coil, an electric heating tube or a ceramic heater. The heating means (24) heats up the air inhaled by the aspiring module (2) in a range between 40° C. and 60° C. . Since the survival of house dust mites and their eggs become critical after reaching 55° C., it is expected that heated air can eradicate the house dust mites efficiently.

The cover (12) of the body (1) includes an opening (125) for accommodating a handle (4), and two longitudinal grooves (41) are provided in parallel fashion at a bottom thereof. Each groove (41) can receives a corresponding stop block (111) which disposed onto the substrate (11). The grooves (41) allow the handle (4) to be extracted for carrying the device and retracted for reducing space. Both stop blocks (111) secure the handle (4) to prevent it disengaging from the body (1).

The device comprises multiples buttons (3) to control the principal functions thereof. Functions and corresponding buttons are listed as follow:
1. Main Switch. A button for controlling the main power source of the device.
2. Heat switch. A button for operating said heating means (24).
3. High speed switch. A button for setting the revolution of the motor (23) to 8000 rpm, which is able to maintain the outputting air in a temperature of 40° C. with the heating means (24) switched on.
4. Medium speed switch. A button for setting the revolution of the motor (23) to 6000 rpm, which is able to maintain the outputting air in a temperature of 50° C. with the heating means (24) switched on. A heat resistant cushion (6) having pluralities openings (61) as shown in FIG. 10 can be attached to the output of the device further. The bedding, such as mattress is accommodated within the cushion (6) to be warmed up by heat air outputting from openings (61), providing comfort to the user under cold weather.
5. Low speed switch. A button for setting the revolution of the motor (23) to 4000 rpm, which is able to maintain the outputting air in a temperature over 60° C. with the heating means (24) switched on. By engaging the device with the heat resistant pad (6) for a period of 10 to 15 minutes, it can eliminate house dust mites who reside therein.

An illuminating element (112) which connected electrically to the PCB (5) encircles about a periphery of the substrate (1); said illuminating element (112) is a plastic tube which incorporates a plurality Light emitting diodes (LEDs). The LEDs may have multiple types of timing sequence, lighting color or lighting pattern in response to the button (3) which is pressed.

1. A multifunction air purifying device comprises of a main body, an aspiring module provided disposed in said body, a printed circuit board (PCB) connected electrically to said aspiring module, and a plurality of buttons, connected electrically to the PCB are disposed on a surface of the body, and characterized in that: said body consists of a substrate, a cover with a suction hole provided at an end thereof is disposed above said substrate, a base with an exhaust hole provided at an end thereof is disposed under said substrate; said base further includes a power socket connected electrically to the PCB for electricity connection;
Said aspiring module includes a housing which has an air intake corresponding and connecting with the suction hole of the cover, and an air outtake corresponding and connecting with the exhaust hole of the base, a centrifugal fan provided about said air intake, a motor for driving said fan, and a heating means provided about said air outtake; and
Said buttons includes a switch button for controlling the power, a plurality buttons for selecting different revolutions of said motor and a button for operating said heating means.

2. The multifunction air purifying device of claim 1, wherein a plurality of legs are disposed at a bottom of the base; each leg joints the base by a post provided respectively at two ends of a top thereof; a guard is further attached to the bottom of said base; and a plurality of grooves are provided at a bottom of said guard for allowing the passage of the legs.

3. The multifunction air purifying device of claim 1, wherein a container is provided at a top of said cover; said container is sealed by a cap and a bottom thereof is attached to an end of a delivery pipe, and an another end thereof connected to said housing of the aspiring module.

4. The multifunction air purifying device of claim 1, wherein a thermal control device is provided at top of the housing where is close to the air outtake for connecting with the delivery pipe; said thermal control device is shut down automatically at 75° C.

5. The multifunction air purifying device of claim 1, wherein said suction hole and a nozzle are engaged, and said outtake and an end of a pipe assembly are engaged; an another end of said pipe assembly is engaged with said exhaust hole.

6. The multifunction air purifying device of claim 5, wherein said nozzle comprises of a tube with an end engaged to the suction hole, and another end engaged to an adapter for connecting to a suction pipe; and a filter provided between said tube and adapter.

7. The multifunction air purifying device of claim 1, wherein a strainer cover is mounted onto said suction hole; said exhaust hole and said air outtake are connected by a filtering cap.

8. The multifunction air purifying device of claim 1, wherein said heating means is selected from one of following: an electric heating plate, an electric heating coil, an electric heating tube or a ceramic heater.

9. The multifunction air purifying device of claim 1, wherein said cover of the body includes an opening for accommodating a handle; two longitudinal grooves are provided in parallel fashion at a bottom of the handle and each groove accommodates a corresponding stop block which disposed onto the substrate.

10. The multifunction air purifying device of claim 1, wherein an illuminating element which connected electrically to the PCB is provided about a periphery of the substrate; said illuminating element is a plastic tube incorporates a plurality Light emitting diodes (LEDs).
